(19) United States
(12) Patent Application Publication
(10) Pub. No.: US 2007/0031002 A1
(43) Pub. Date: Feb. 8, 2007

(54) Method and system for reducing artifacts in image detection

(76) Inventors: Shalini Venkatesh, Santa Clara, CA (US); Richard E. Haven, Sunnyvale, CA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/196,960

(22) Filed: Aug. 4, 2005

(51) Int. Cl. G06K 9/00; G06K 9/68

(52) U.S. Cl. 382/103; 382/218

(57) ABSTRACT

Multiple images of an object are captured by one or more imagers. Each image is captured with one or more differing image capture parameters. Image capture parameters include the status (i.e., on or off), wavelength and position of each light source and the status and position of each imager. Two or more difference images are then generated using at least a portion of the captured images and the difference images analyzed to detect the object. The reflections from artifacts are reduced or largely cancelled out in the difference images when each image is captured with one or more different image capture parameters.

### BACKGROUND

There are a number of applications in which it is of interest to detect or image an object. One detection technique is wavelength-encoded imaging, which typically involves detecting light propagating at different wavelengths. Images of the object are captured using the light and the images analyzed to detect the object in the images.

FIG. 1 is a diagram of a system that uses wavelength-encoded imaging for pupil detection according to the prior art. This system is disclosed in commonly assigned U.S. patent application Ser. No. 10/739,831, filed on Dec. 18, 2003, which is incorporated herein by reference. Light source 100 emits light 102 towards subject 104 at one wavelength (λ₁) while light source 106 emits light 108 towards subject 104 at a different wavelength (λ₂). Imager 110 captures images of subject 104 using light 112 reflected off subject 104. Processing unit 114 then subtracts one image from another to generate a difference image and the pupil or pupils of subject 104 detected in the difference image.

The pupils captured with the light propagating at wavelength (λ₁) are typically brighter in an image than the pupils captured with the light propagating at wavelength (λ₂). This is due to the retro-reflection properties of the pupils and the positions of light sources 100, 106 with respect to imager 110. But elements other than the pupils can reflect a sufficient amount of light at both wavelengths to cause artifacts in the different images. FIG. 2 is a graphic illustration of a difference image generated by the system of FIG. 1. Image 200 includes pupil 202 and artifact 204. Artifact 204 can make it difficult to detect pupil 202 in image 200 because a system may be unable to distinguish pupil 202 from artifact 204 or may erroneously determine artifact 204 is pupil 202.

### SUMMARY

In accordance with the invention, a method and system for reducing artifacts in image detection are provided. Multiple images of an object are captured by one or more imagers. Each image is captured with one or more differing image capture parameters. Image capture parameters include the status (i.e., on or off), wavelength and position of each light source and the status and position of each imager. Two or more difference images are then generated using at least a portion of the captured images and the difference images analyzed to detect the object. The reflections from artifacts are reduced or largely cancelled out in the difference images when each image is captured with one or more different image capture parameters.

### BRIEF DESCRIPTION OF THE DRAWINGS

FIG. 1 is a diagram of a system that uses wavelength-encoded imaging for pupil detection according to the prior art;

FIG. 2 is a graphic illustration of a difference image generated by the system of FIG. 1;

FIG. 3 is a diagram of a first system for pupil detection in an embodiment in accordance with the invention;

FIG. 4A is a graphic illustration of a first sub-frame image in a first composite image generated with an on-axis light source in accordance with the embodiment of FIG. 3;

FIG. 4B is a graphic illustration a second sub-frame image in the first composite image generated with an off-axis light source in accordance with the embodiments of FIG. 3;

FIG. 4C is a graphic illustration of a first difference image resulting from the difference between the FIG. 4A sub-frame image and the FIG. 4B sub-frame image;

FIG. 4D is a graphic illustration a first sub-frame image in a second composite image generated with a different on-axis light source in accordance with the embodiments of FIG. 3;

FIG. 4E is a graphic illustration a second sub-frame image in a second composite image generated with a different off-axis light source in accordance with the embodiments of FIG. 3;

FIG. 4F is a graphic illustration of a second difference image resulting from the difference between the FIG. 4D sub-frame image and the FIG. 4E sub-frame image;

FIG. 5 is a diagram of a second system for pupil detection in an embodiment in accordance with the invention;

FIG. 6 is a diagram of a third system for pupil detection in an embodiment in accordance with the invention;

FIG. 7 is a flowchart of a first method for reducing artifacts in an embodiment in accordance with the invention;

FIG. 8 is a flowchart of a second method for reducing artifacts in an embodiment in accordance with the invention;

FIG. 9 is a top-view of a first sensor that may be used in the embodiment of FIG. 3;

FIG. 10 is a cross-sectional diagram of an imager that may be used in the embodiment of FIG. 3;

FIG. 11 depicts the spectrum for the imager of FIG. 10; and

FIG. 12 is a top-view of a second sensor that may be used in the embodiments of FIGS. 3-6.

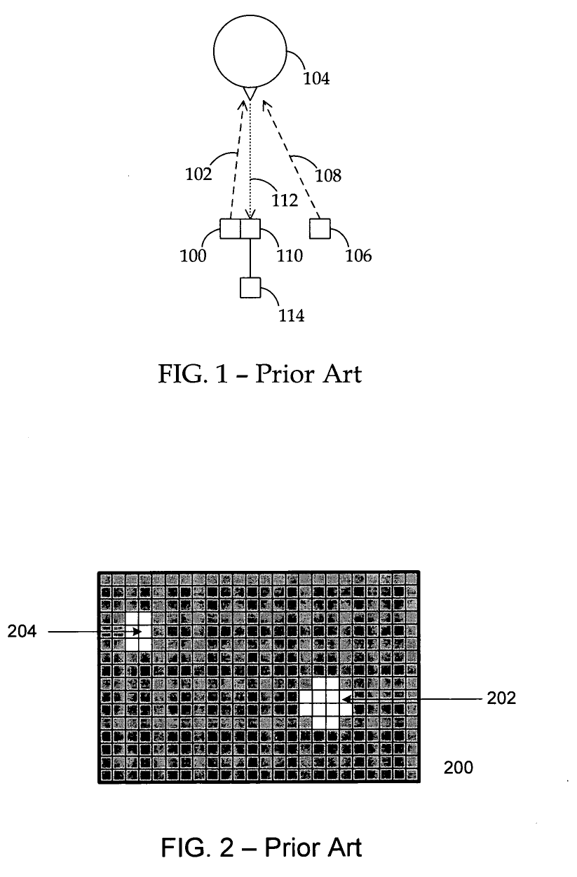

### DETAILED DESCRIPTION

The following description is presented to enable one skilled in the art to make and use embodiments of the invention, and is provided in the context of a patent application and its requirements. Various modifications to the disclosed embodiments will be readily apparent to those skilled in the art, and the generic principles herein may be applied to other embodiments. Thus, the invention is not intended to be limited to the embodiments shown, but is to be accorded the widest scope consistent with the appended claims and with the principles and features described herein. It should be understood that the drawings referred to in this description are not drawn to scale.

Techniques for detecting one or both pupils in the eyes of a subject are included in the detailed description as exemplary image detection systems. Embodiments in accordance with the invention, however, are not limited to these applications. For example, embodiments in accordance with the invention may employ image detection to detect movement along an earthquake fault, detect the presence, attentiveness, or location of a person or subject, and to detect moisture in a manufacturing subject. Additionally, embodiments in accordance with the invention may use image detection in medical and biometric applications, such as, for example, systems that detect fluids or oxygen in tissue and systems that identify individuals using their eyes or facial features.

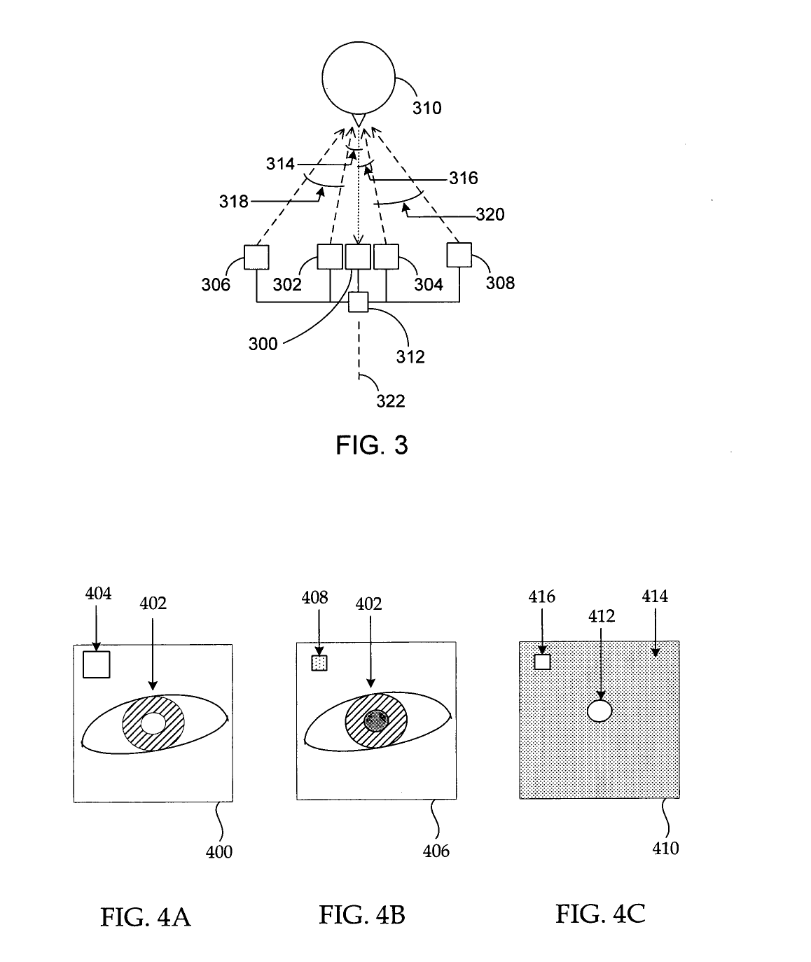

Like reference numerals designate corresponding parts throughout the figures. FIG. 3 is a diagram of a first system for pupil detection in an embodiment in accordance with the invention. The system includes imager 300 and light sources 302, 304, 306, 308. Light sources 302, 306 emit light at one wavelength (λ₁) while light sources 304, 308 emit light at a different wavelength (λ₂) in an embodiment in accordance with the invention.

Using light reflected off subject 310, imager 300 captures two composite images of the face, the eyes, or both the face and the eyes of subject 310 in an embodiment in accordance with the invention. A composite image is an image constructed from two sub-frame images that form a complete image of the object when combined. One composite image is taken with light sources 302, 308 turned on and light sources 304, 306 turned off. Thus, one sub-frame image in the composite image is captured with light from light source 302 (λ₁) and the other sub-frame image is captured with light from light source 308 (A₂).

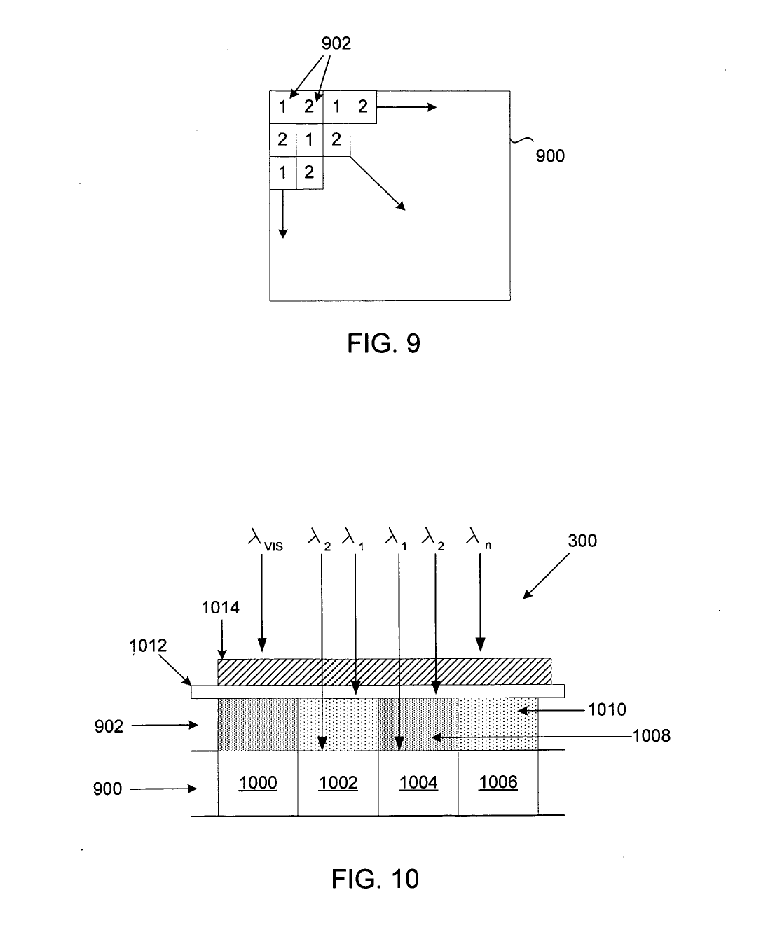

The other composite image is taken with light sources 304, 306 turned on and light sources 302, 308 turned off. One sub-frame image in this composite image is captured with light from light source 306 (λ₁) and the other sub-frame image is captured with light from light source 304 (λ₂). An imager capable of capturing sub-frames using light propagating at different wavelengths is discussed in more detail in conjunction with FIGS. 9-11.

Processing unit 312 generates two difference images by subtracting one sub-frame image in a composite image from the other sub-frame image. Processing unit 312 analyzes the two difference images to distinguish and detect a pupil (or pupils) from the other features within the field of view of imager 300. When the eyes of subject 310 are open, the difference between the sub-frames in each composite image highlights the pupil of one or both eyes. The reflections from other facial and environmental features (i.e., artifacts) are largely cancelled out in the difference images by reversing the positions of the light sources emitting light at wavelength (λ₁) and wavelength (λ₂).

Thus, the status (i.e., turned on or off), wavelength, position, and number of light sources are image capture parameters in an embodiment in accordance with the invention. One or more of the image capture parameters are changed after each image is captured in an embodiment in accordance with the invention. Alternatively, in other embodiments in accordance with the invention, the one or more differing image capture parameters may be present when previous or contemporaneous image or images are captured but not used to capture the previous or contemporaneous image or images. For example, in the embodiment of FIG. 3, when a sub-frame image is captured with light from light source 308 (λ₂) light from light source 302 (λ₁) is present but not used to capture the sub-frame.

Processing unit 312 may be a dedicated processing unit or it may be a shared device. The amount of time the eyes of subject 310 are open or closed can be monitored against a threshold in an embodiment in accordance with the invention. Should the threshold not be satisfied (e.g. the percentage of time the eyes are open falls below the threshold), an alarm or some other action can be taken to alert subject 310. The frequency or duration of blinking may be used as a criterion in other embodiments in accordance with the invention.

Light sources that are used in systems designed to detect pupils typically emit light that yields substantially equal image intensity (brightness). Moreover, the wavelengths are generally chosen such that the light will not distract subject 310 and the iris of the eye or eyes will not contract in response to the light. “Retinal return” refers to the intensity (brightness) that is reflected off the back of the eye of subject 310 and detected at imager 300. “Retinal return” is also used to include reflection from other tissue at the back of the eye (other than or in addition to the retina). Differential reflectivity off a retina of subject 310 is dependent upon angles 314, 316 and angles 318, 320 in an embodiment in accordance with the invention. In general, decreasing the sizes of angles 314, 316 increases the retinal return. Accordingly, the sizes of angles 314, 316 are selected such that light sources 302, 304 are on or close to axis 322 (“on-axis light sources”). In an embodiment in accordance with the invention, the sizes of angles 314, 316 are typically in the range of approximately zero to two degrees. Angles 314, 316 may be different sized angles or equal in size angles in embodiments in accordance with the invention.

The sizes of angles 318, 320 are selected so that only low retinal return from light sources 306, 308 is detected at imager 300. The iris (surrounding the pupil) blocks this signal, and so pupil size under different lighting conditions should be considered when selecting the size of angles 318, 320. The sizes of angles 318, 320 are selected such that light sources 306, 308 are positioned away from axis 322 (“off-axis light sources”). In an embodiment in accordance with the invention, the sizes of angles 316, 318 are typically in the range of approximately three to fifteen degrees. Angles 318, 320 may be different sized angles or equal in size angles in embodiments in accordance with the invention.

Light sources 302, 304, 306, 308 are implemented as light-emitting diodes (LEDs) or multi-mode semiconductor lasers having infrared or near-infrared wavelengths in an embodiment in accordance with the invention. In other embodiments in accordance with the invention, light sources 302, 304, 306, 308 may be implemented with different types and different numbers of light sources. For example, light sources 302, 304, 306, 308 may be implemented as a single broadband light source, such as, for example, the sun.

Light sources 302, 304, 306, 308 may also emit light with different wavelength configurations in other embodiments in accordance with the invention. For example, light sources 302,304 may emit light at one wavelength, light source 306 at a second wavelength, and light source 308 at a third wavelength in an embodiment in accordance with the invention. By way of another example, light sources 302, 304, 306, 308 may emit light at four different wavelengths.

And finally, the positioning of the light sources may be different from the configuration shown in FIG. 3 in other embodiments in accordance with the invention. The number, position, and wavelengths of the light sources are determined by the application and the environment surrounding the subject or object to be detected.

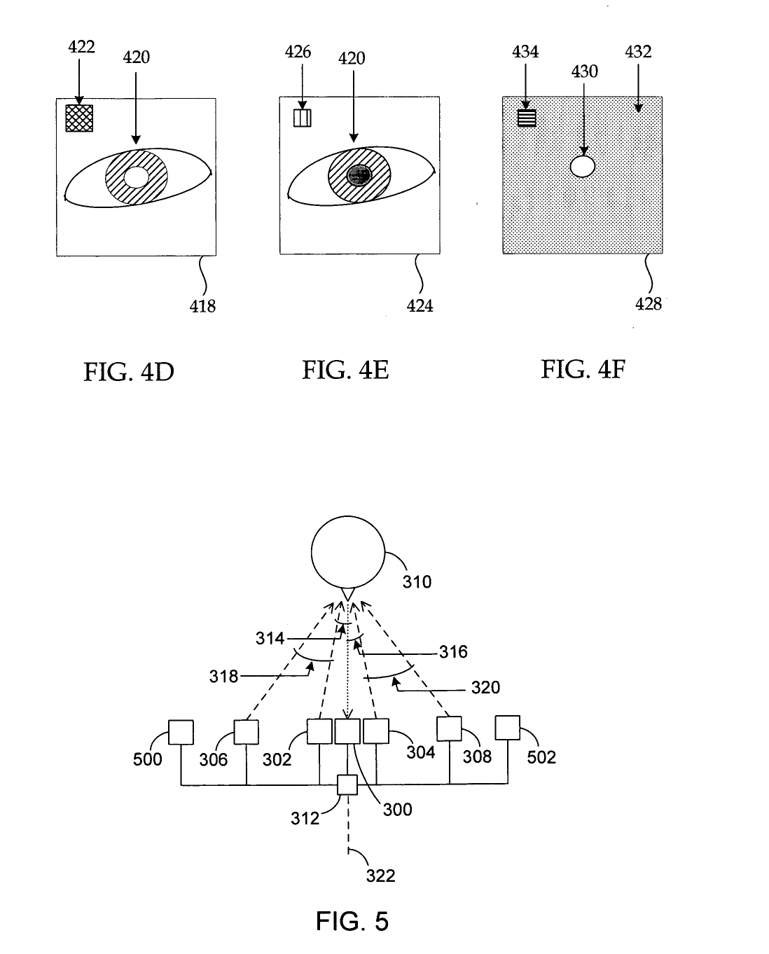

FIG. 4A is a graphic illustration of a first sub-frame image in a first composite image generated with an on-axis light source in accordance with the embodiment of FIG. 3. Sub-frame image 400 shows an open eye 402 and artifact 404. Eye 402 has a bright pupil due to a strong retinal return created by one or more light sources. If eye 402 had been closed, or nearly closed, the bright pupil would not be detected and imaged.

FIG. 4B is a graphic illustration of a second sub-frame image in a first composite image generated with an off-axis light source in accordance with the embodiment of FIG. 3. Sub-frame image 406 may be taken at the same time as sub-frame image 400, or it may be taken in an alternate frame (successively or non-successively). Sub-frame image 406 illustrates eye 402 with a normal, dark pupil and another artifact 408. If the eye had been closed or nearly closed, the dark pupil would not be detected and imaged.

FIG. 4C is a graphic illustration of a difference image resulting from the difference between the FIG. 4A sub-frame image and the FIG. 4B sub-frame image. By taking the difference between sub-frame images 400 and 406, difference image 410 includes a relatively bright spot 412 against a relatively dark background 414 when the eye is open. When the eye is closed or nearly closed, bright spot 412 will not be shown in difference image 410. Difference image 410 also includes artifact 416.

FIG. 4D is a graphic illustration of a first sub-frame image in a second composite image generated with an on-axis light source in accordance with the embodiment of FIG. 3. Sub-frame image 418 shows an open eye 420 and artifact 422. Eye 420 has a bright pupil due to a strong retinal return created by one or more light sources.

FIG. 4E is a graphic illustration of a second sub-frame image in a second composite image generated with an off-axis light source in accordance with the embodiment of FIG. 3. Sub-frame image 424 may be taken at the same time as sub-frame image 418, or it may be taken in an alternate frame (successively or non-successively). Sub -frame image 424 illustrates eye 420 with a normal, dark pupil and another artifact 426.

FIG. 4F is a graphic illustration of a difference image resulting from the difference between the FIG. 4D sub-frame image and the FIG. 4E sub-frame image. Difference image 428 includes a relatively bright spot 430 against a relatively dark background 432 when the eye is open. Difference image 428 also includes artifact 434. The relatively bright spots 412 and 430 in difference images 410, 428, respectively, are nearly the same size and brightness while artifact 416 has a different size, shape, or brightness level in difference image 410 than artifact 434 in difference image 428. This is due to the different positions and wavelengths of the light sources during image capture, which cause light to reflect differently off of the artifacts. Artifact 416 appears different from artifact 434, which allows a detection system to disregard artifacts 416, 434 and identify spots 412,430 as a pupil.

FIGS. 4A-4F illustrate one eye of a subject. Both eyes may be monitored in other embodiments in accordance with the invention. It will also be understood that a similar effect will be achieved if the images include other features of the subject (e.g. other facial features), as well as features of the subject's environment. These features will largely cancel out in a manner similar to that just described.

Referring to FIG. 5, there is shown a diagram of a second system for pupil detection in an embodiment in accordance with the invention. The system includes imager 300, on-axis light sources 302, 304, off-axis light sources 306, 308, and processing unit 312 from FIG. 3. Light sources 302, 308 propagate light at one wavelength while light sources 304, 306 propagate light at a different wavelength in an embodiment in accordance with the invention.

The embodiment of FIG. 5 also includes imagers 500, 502. The pupil detection system of FIG. 5 uses multiple imagers located at different positions and light sources emitting light at different wavelengths to capture images of subject 310. Light sources 302, 304, 306, 308 are turned on and off either in groups or individually in order to capture multiple images of subject 310.

Three or more distinct images are captured by imagers 300, 500, 502 in the FIG. 5 embodiment. The three images are then used to generate two or more difference images. The images are captured individually or concurrently, depending on which particular wavelength or angle is used during image capture. Thus, the position of an imager and the position of a light source change during image capture in the embodiment of FIG. 5.

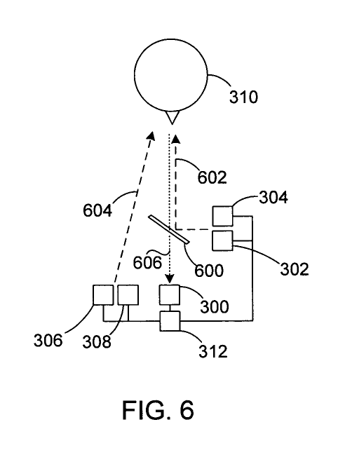

FIG. 6 is a diagram of a third system for pupil detection in an embodiment in accordance with the invention. The system includes imager 300, on-axis light sources 302, 304, off-axis light sources 306, 308, and processing unit 312 from FIG. 3. Light sources 302, 308 propagate light at one wavelength while light sources 304, 306 propagate light at a different wavelength in an embodiment in accordance with the invention.

Two or more composite images are taken of the face, eyes, or both face and eyes of subject 310 using imager 300. One composite image is taken with light sources 302, 308 turned on and light sources 304, 306 turned off. The other composite image is taken with light sources 304, 306 turned on and light sources 302, 308 turned off. To capture an image, an on-axis light source (e.g., 302) emits a beam of light towards beam splitter 600. Beam splitter 600 splits the light into two segments with one segment 602 directed towards subject 310 (only one segment is shown for clarity). A smaller yet effective on-axis angle of illumination is permitted when beam splitter 600 is placed between imager 300 and subject 310.

An off-axis light source (e.g., 308) also emits a beam of light 604 towards subject 310. Light from segments 602, 604 reflects off subject 310 towards beam splitter 600. Light from segments 602, 604 may simultaneously reflect off subject 310 or alternately reflect off subject 310, depending on when light sources 302, 304, 306, 308 emit light. Beam splitter 600 splits the reflected light into two segments and directs one segment 606 towards imager 300. Imager 300 captures two composite images of subject 310 using the reflected light and transmits the images to processing unit 312 for processing.

Although FIG. 3 and FIG. 6 have been described as capturing composite images and FIG. 5 as capturing distinct images, these embodiments are not limited to this implementation. The embodiments shown in FIGS. 3 and 6 may be used to capture distinct images and the embodiment of FIG. 5 may capture composite images. The embodiments of FIGS. 3, 5, and 6 have also been described as capturing images with reflected light. Other embodiments in accordance with the invention may capture light that is transmitted through or towards an object.

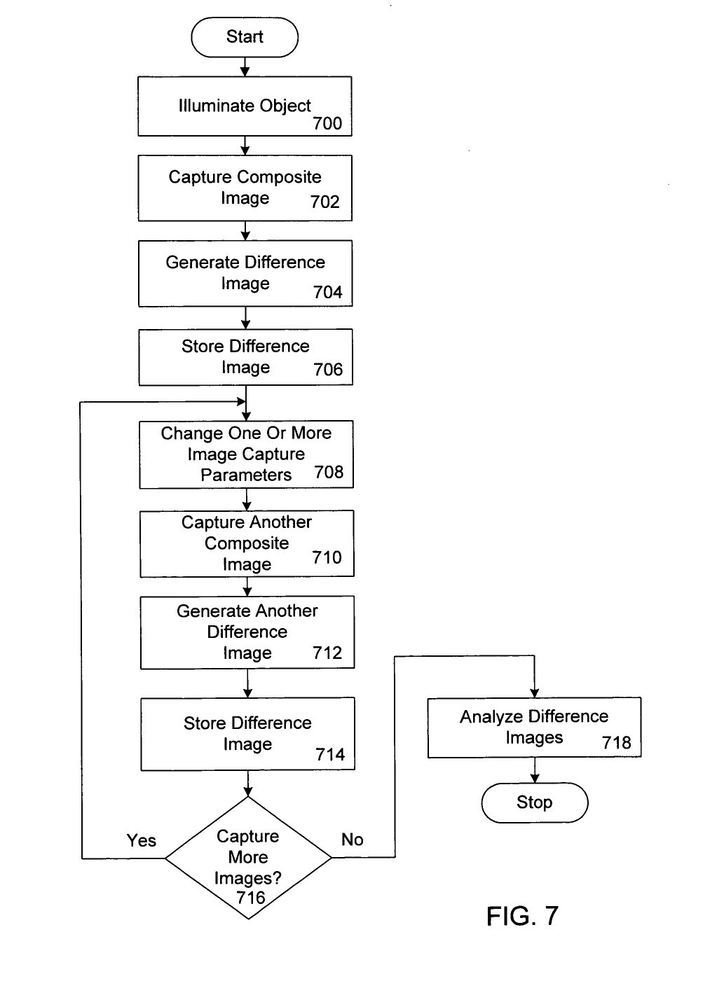

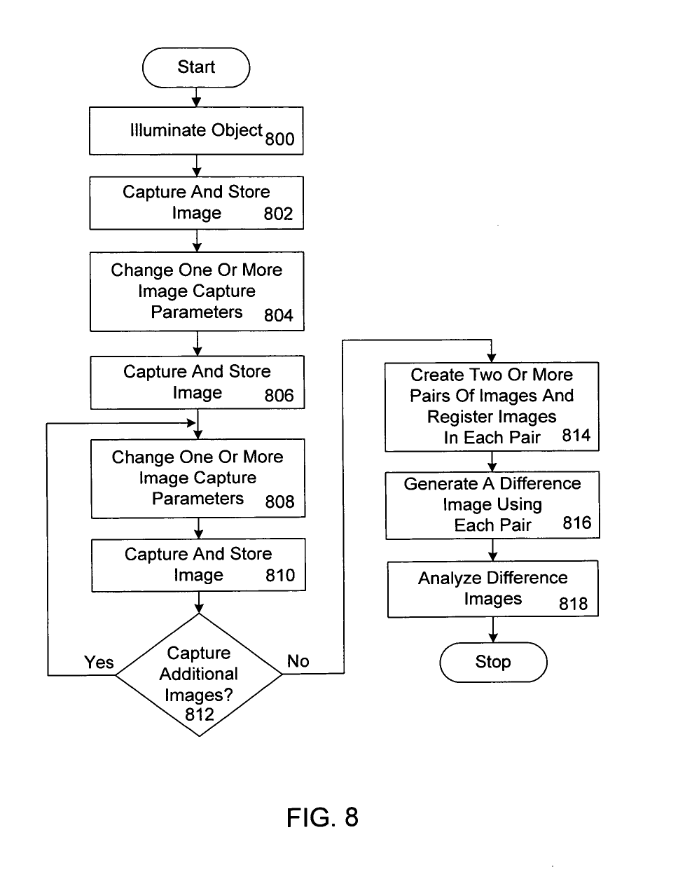

Referring to FIG. 7, there is shown a flowchart of a first method for reducing artifacts in an embodiment in accordance with the invention. Initially an object is illuminated, as shown in block 700. The object is simultaneously illuminated with light sources emitting light at two or more different wavelengths in an embodiment in accordance with the invention. For example, in the embodiment of FIG. 3, subject 310 is illuminated with light sources 302, 308 at block 700.

A composite image of the object is then taken, as shown at block 702. As discussed earlier, a composite image is formed from two sub-frames which, when combined, form a complete image of the object. An imager capable of capturing composite images is described in more detail in conjunction with FIGS. 9-11.

Next, at block 704, a difference image is generated by subtracting one sub-frame in the composite image from the other sub-frame. The difference image is then stored, as shown in block 706. The difference image is generated by subtracting the grayscale values in the two sub-frames on a pixel-by-pixel basis in an embodiment in accordance with the invention. In other embodiments in accordance with the invention, the difference image may be generated using other techniques. For example, a difference image may be generated by separately grouping sets of pixels together in the two sub-frames, averaging the grayscale values for the groups, and then subtracting one average value from the other average value.

One or more image capture parameters are then changed at block 708 and a second composite image captured (block 710). As discussed earlier, the number, status (i.e., turned on or off), wavelength, and position of the light sources are image capture parameters in an embodiment in accordance with the invention. In another embodiment in accordance with the invention, the number and position of imagers are image capture parameters in addition to the number, status, position, and wavelengths of the light sources.

Another difference image is then generated and stored, as shown in blocks 712, 714. A determination is made at block 716 as to whether additional composite images are to be captured. If so, the process returns to block 708 and repeats until a given number of difference images have been generated. The difference images are then analyzed at block 718. The analysis includes comparing the difference images with respect to each other to distinguish and detect a pupil (or pupils) from any artifacts in the difference images.

Analysis of the difference images may also include any type of image processing. For example, the difference images may be averaged on a pixel-by-pixel basis or by groups of pixels basis. Averaging the difference images can reduce the brightness of any artifacts while maintaining the brightness of the retinas. Other types of image analysis or processing may be implemented in other embodiments in accordance with the invention. For example, a threshold may be applied to the difference images to include or exclude values that meet or exceed the threshold or that fall below the threshold.

FIG. 8 is a flowchart of a second method for reducing artifacts in an embodiment in accordance with the invention. The method illustrated in FIG. 8 captures three or more distinct images which are used to generate two or more difference images. Initially an object is illuminated and an image of the object captured and stored, as shown in blocks 800, 802.

One or more image capture parameters are changed and another image of the object captured and stored (blocks 804, 806). One or more image capture parameters are changed again and a third image of the object captured and stored (blocks 808, 810). A determination is then made at block 812 as to whether more images of the object are to be captured. If so, the method returns to block 808 and repeats until a given number of images have been captured.

After all of the images are captured, the method passes to block 814 where the captured images are paired together to create two or more pairs of images. The images in each pair are also registered in an embodiment in accordance with the invention so that one image is aligned with the other image. A difference image is generated for each pair of images at block 816. The difference images are then analyzed, as shown in block 818. As discussed earlier, the analysis includes comparing the difference images with respect to each other to distinguish and detect a pupil (or pupils) from any artifacts in the difference images.

The embodiments shown in FIGS. 7 and 8 describe changing one or more image capture parameters before capturing a subsequent image. Embodiments in accordance with the invention, however, are not limited to this implementation. As discussed earlier, the one or more differing image capture parameters may be present when previous or contemporaneous image or images are captured but not used to capture the previous or contemporaneous image or images. For example, light propagating at two or more wavelengths may be present during the entire image capture process. Multiple imagers may be used with each having a different range of detectable wavelengths. As another example, each imager may use one or more filters to distinguish and detect one or more particular wavelengths from the multiple wavelengths present during image capture.

Referring to FIG. 9, there is shown a top-view of a first sensor that may be used in the embodiment of FIG. 3. Sensor 900 is incorporated into imager 300 and is configured as a complementary metal-oxide semiconductor (CMOS) imaging sensor. Sensor 900 may be implemented with other types of imaging devices in other embodiments in accordance with the invention, such as, for example, a charge-coupled device (CCD) imager.

Patterned filter layer 902 is formed on sensor 900 using different filter materials shaped into a checkerboard pattern. The two filters are determined by the wavelengths being used by light sources 302, 304, 306, 308. For example, in the embodiment of FIG. 3, patterned filter layer 902 includes regions (identified as 1) that include a filter material for selecting the wavelength used by light sources 302, 308 while other regions (identified as 2) include a filter material for selecting the wavelength used by light sources 304, 306.

Patterned filter layer 902 is deposited as a separate layer of sensor 900 while still in wafer form, such as, for example, on top of an underlying layer, using conventional deposition and photolithography processes in an embodiment in accordance with the invention. In another embodiment in accordance with the invention, patterned filter layer 902 can be created as a separate element between sensor 900 and incident light. Additionally, the pattern of the filter materials can be configured in a pattern other than a checkerboard pattern. For example, patterned filter layer 902 can be formed into an interlaced striped or a non-symmetrical configuration (e.g. a 3-pixel by 2-pixel shape). Patterned filter layer 902 may also be incorporated with other functions, such as color imagers.

Various types of filter materials can be used in patterned filter layer 902. In this embodiment in accordance with the invention, the filter materials include polymers doped with pigments or dyes. In other embodiments in accordance with the invention, the filter materials may include interference filters, reflective filters, and absorbing filters made of semiconductors, other inorganic materials, or organic materials.

FIG. 10 is a cross-sectional diagram of an imager that may be used in the embodiment of FIG. 3. Only a portion of imager 300 is shown in this figure. Imager 300 includes sensor 900 comprised of pixels 1000, 1002, 1004, 1006, patterned filter layer 902 including two alternating filter regions 1008, 1010, glass cover 1012, and dual-band narrowband filter 1014. Patterned filter layer 902 as two polymers 1008, 1010 doped with pigments or dyes in this embodiment in accordance with the invention. Each region in patterned filter layer 902 (e.g. a square in the checkerboard pattern) overlies a pixel in the CMOS imager.

Narrowband filter 1014 and patterned filter layer 902 form a hybrid filter in this embodiment in accordance with the invention. When light strikes narrowband filter 1014, the light at wavelengths other than the wavelengths of light sources 302, 308 (λ₁) and light sources 304, 306 (λ₂) is filtered out, or blocked, from passing through the narrowband filter 1014. Light propagating at visible wavelengths (λ_{VIS}) and wavelengths (λₙ) is filtered out in this embodiment, where λₙ represents a wavelength other than λ₁, λ₂, and λ_{VIS}. Light propagating at or near wavelengths λ₁ and λ₂ pass through narrowband filter 1014. Thus, only light at or near the wavelengths λ₁ and λ₂ passes through glass cover 1012. Thereafter, polymer 1008 transmits the light at wavelength λ₁ while blocking the light at wavelength λ₂. Consequently, pixels 1000 and 1004 receive only the light at wavelength λ₁, thereby generating the image taken with the light sources 302, 308.

Polymer 1010 transmits the light at wavelength λ₂ while blocking the light at wavelength λ₁, so that pixels 1002 and 1006 receive only the light at wavelength λ₂. In this manner, the image taken with light sources 304, 306 is generated. Narrowband filter 1014 is a dielectric stack filter in an embodiment in accordance with the invention. Dielectric stack filters are designed to have particular spectral properties. For the embodiment shown in FIG. 3, the dielectric stack filter is formed as a dual-band narrowband filter. Narrowband filter 1014 is designed to have one peak at λ₁ and another peak at λ₂.

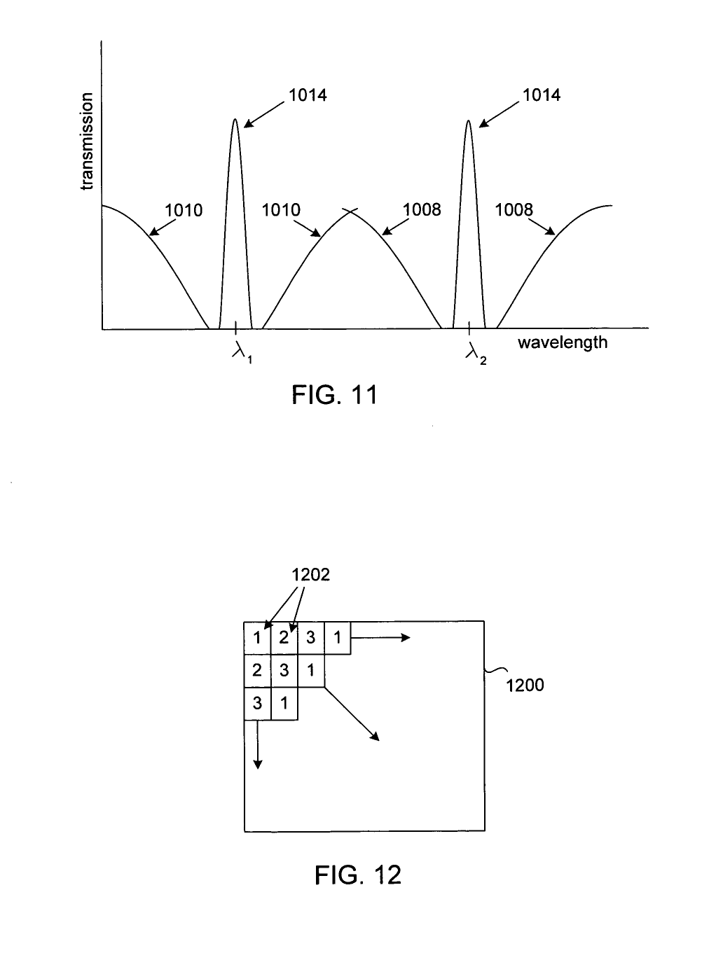

FIG. 11 depicts the spectrum for the imager of FIG. 10. The hybrid filter (combination of the polymer filters 1008, 1010 and narrowband filter 1014) effectively filters out all light except for the light at or near the wavelengths of the light sources (λ₁ and λ₂). Narrowband filter 1014 transmits a narrow amount of light at or near the wavelengths of interest, λ₁ and λ₂, while blocking the transmission of light at other wavelengths. Patterned filter layer 902 then discriminates between λ₁ and λ₂. Wavelength λ₁ is transmitted through filter 1008 (and not through filter 1010), while wavelength λ₂ is transmitted through filter 1010 (and not through filter 1008).

Referring to FIG. 12, there is shown a top-view of a second sensor that may be used in the embodiments of FIGS. 3-6. Sensor 1200 is used to capture images with light sources emitting light at three different wavelengths. Thus, in the embodiment of FIG. 3 for example, light source 304 may be omitted while light source 302 emits light at one wavelength(λ₁), light source 308 at a second wavelength (λ₂), and light source 306 at a third wavelength (λ₃). Sensor 1200 may then be used to capture images of an object using light propagating at each wavelength.

Patterned filter layer 1202 is formed on sensor 1200 using three different filters. Each filter region transmits only one of the three wavelengths. For example, in one embodiment in accordance with the invention, sensor 1200 may include a color three-band filter pattern. Region 1 transmits light at λ₁, region 2 at λ₂, and region 3 at λ₃. When the captured images are distinct images, the images are paired together to generate at least two difference images and the difference images analyzed as discussed earlier. When the captured images are composite images, two or more difference images are generated by subtracting one sub-frame in a composite image from the other sub-frame in the composite image. The difference images are then analyzed to distinguish and detect an object.

1. A system for detecting an object using two or more difference images, the system comprising:
one or more light sources operable to emit light towards the object, wherein the light propagates at two or more different wavelengths; and
one or more imagers operable to capture multiple images of an object, wherein each image is captured with one or more differing image capture parameters.

2. The system of claim 1, further comprising a processing unit operable to generate the two or more difference images using at least a portion of the captured multiple images and process the two or more difference images to detect the object.

3. The system of claim 2, wherein the one or more image capture parameters comprise at least one of a position of an imager, a status of an imager, a position of a light source, a wavelength of a light source, and a status of a light source.

4. The system of claim 1, wherein the one or more light sources comprises a single broadband light source operable to emit light at two or more wavelengths.

5. The system of claim 1, wherein the one or more light sources comprises two or more light sources each operable to emit light at at least one wavelength that differs from a wavelength emitted by another light source.

6. A system for detecting an object using two or more difference images, the system comprising:
one or more imagers operable to capture multiple images of an object, wherein each image is captured with one or more differing image capture parameters; and
a processing unit operable to generate the two or more difference images using at least a portion of the captured multiple images and process the two or more difference images to detect the object.

7. The system of claim 6, further comprising one or more light sources operable to emit light towards the object, wherein the light propagates at two or more different wavelengths.

8. The system of claim 7, wherein the one or more image capture parameters comprise at least one of a position of an imager, a status of an imager, a position of a light source, a wavelength of a light source, and a status of a light source.

9. The system of claim 7, wherein the one or more light sources comprises a single broadband light source emitting light at two or more wavelengths.

10. The system of claim 7, wherein the one or more light sources comprises two or more light sources each operable to emit light at at least one wavelength that differs from a wavelength emitted by another light source.

11. A method for detecting an object using two or more difference images, comprising:
capturing a first image of an object using a first set of image capture parameters;
capturing a second image of the object using a second set of image capture parameters;
capturing a third image of the object using a third set of image capture parameters;
generating the two or more difference images using pairs of captured images;
analyzing at least two difference images with respect to each other; and
detecting the object based on the analysis of the difference images.

12. The method of claim 11, further comprising:
capturing additional images of the object using a different set of image capture parameters for each additional image; and
generating additional difference images using pairs of captured images prior to analyzing at least two difference images with respect to each other.

13. The method of claim 12, further comprising emitting light towards the object, wherein the light propagates at two or more different wavelengths.

14. The method of claim 12, wherein the captured images comprise distinct images.

15. The method of claim 11, further comprising capturing a fourth image using a fourth set of image capture parameters.

16. The method of claim 15, wherein the first image comprises a first sub-frame in a first composite image, the second image a second sub-frame in the first composite image, the third image a first sub-frame in a second composite image, and the fourth image a second sub-frame in the second composite image.

17. The method of claim 16, wherein generating two or more difference images using pairs of captured images comprises generating a first difference image by subtracting the first sub-frame in the first composite image from the second sub-frame in the first composite image and generating a second difference image by subtracting the first sub-frame in the second composite image from the second sub-frame in the second composite image.

18. The method of claim 12, wherein each set of image capture parameters comprises at least one of a position of an imager, a status of an imager, a position of a light source, a wavelength of a light source, and a status of a light source.

19. The method of claim 11, wherein at least a portion of the images of the object are captured simultaneously.

20. The method of claim 11, wherein the images of the object are captured successively.
